(19) United States
(12) Patent Application Publication
(10) Pub. No.: US 2026/0331991 A1
(43) Pub. Date: Oct. 22, 2026

(54) DYNAMIC SEAL AND A IN-WHEEL MOTOR INCLUDING SAME

(71) Applicants: HYUNDAI MOTOR COMPANY, Seoul (KR); KIA CORPORATION, Seoul (KR)

(72) Inventors: Ki Tack Lim, Hwaseong-si (KR); Jeong Uk An, Hwaseong-si (KR); Chee Mann Kim, Hwaseong-si (KR); Kam Chun Lee, Hwaseong-si (KR); Hong Wook Lee, Hwaseong-si (KR); Kyung Ku Yeo, Hwaseong-si (KR)

(73) Assignees: HYUNDAI MOTOR COMPANY, Seoul (KR); KIA CORPORATION, Seoul (KR)

(21) Appl. No.: 19/381,682

(22) Filed: Nov. 6, 2025

(30) Foreign Application Priority Data
Apr. 22, 2025 (KR) 10-2025-0052005

(51) Int. Cl. H02K 5/10; F16J 15/3232; H02K 21/22

(52) U.S. Cl. CPC H02K 5/10; F16J 15/3232; H02K 21/22

(57) ABSTRACT

An in-wheel motor includes a stator, a rotor rotatable with respect to the stator, and a seal disposed on the stator and configured to contact the rotor. The seal may include a first lip and a second lip spaced apart from the first lip. The first lip and the second lip may contact the rotor and have an overlap amount of zero with the rotor. In particular, the rotor includes a slinger coupled to the rotor, and the seal is disposed to contact the slinger.

### CROSS-REFERENCE TO RELATED APPLICATION

This application claims under 35 U.S.C. § 119(a) the benefit of and priority to Korean Patent Application No. 10-2025-0052005, filed on Apr. 22, 2025, the entire contents of which are incorporated herein by reference.

### TECHNICAL FIELD

The present disclosure relates to a dynamic seal and application of the same.

### BACKGROUND

The statements in this section merely provide background information related to the present disclosure and may not constitute prior art.

Recently, electric vehicles driven by a motor instead of an engine have attracted significant attention. Electric vehicles are typically driven by one or two large motors. In-wheel motors, which are widely employed in small vehicles, such as electric bicycles and scooters, have more recently been adopted in electric vehicles.

An in-wheel motor is an electric motor that is mounted within a wheel of a vehicle and directly rotates the wheel. Specifically, in an electric vehicle driven by the in-wheel motor, a small motor is mounted within each wheel such that each wheel may be driven and controlled independently.

Compared to an electric vehicle employing a conventional large motor, the electric vehicle employing the in-wheel motor may provide great space efficiency and enhanced control performance. However, due to the characteristic that a motor is provided in each wheel, the electric vehicle driven by the in-wheel motor should meet different design requirements than an electric vehicle driven by a single large motor.

### SUMMARY

Embodiments of the present disclosure provide a dynamic seal, which may provide excellent sealing performance for a space between a rotating body and a stationary body, and an in-wheel motor including the same.

In an embodiment, an in-wheel motor includes a stator, a rotor rotatable with respect to the stator, and a seal disposed on the stator and configured to contact the rotor. The seal may include a first lip and a second lip spaced apart from the first lip. The first lip and the second lip may contact the rotor and have an overlap amount of zero with the rotor.

In an embodiment, an in-wheel motor includes a stator, a rotor disposed on an outer side of the stator and configured to rotate relative to the stator, a seal disposed on the stator, and a slinger disposed on the rotor. The slinger may be configured to contact the seal. The seal may include a first lip, a second lip spaced apart from the first lip, and a third lip disposed between the first lip and the second lip. The first lip, the second lip, and the third lip may contact the slinger. An overlap amount between the first and second lips and the slinger may be zero. An overlap amount between the third lip and the slinger may be greater than zero.

In an embodiment, a dynamic seal includes a first lip, a second lip spaced apart from the first lip, and a third lip disposed between the first lip and the second lip. The first lip, the second lip, and the third lip may contact a rotor. The rotor is configured to rotate relative to a stator and includes a slinger. An overlap amount between the first and second lips and the slinger is zero, and an overlap amount between the third lip and the slinger may be greater than zero.

Disclosed embodiments may provide a dynamic seal, which may provide excellent sealing performance for a space between a rotating body and a stationary body, and an in-wheel motor including the same.

### BRIEF DESCRIPTION OF THE DRAWINGS

FIG. 1 is a cross-sectional view of an in-wheel motor according to an embodiment of the present disclosure.

FIG. 2 is an enlarged view of portion S1 in FIG. 1.

FIG. 3 is a view illustrating an inner seal and a slinger in FIG. 2.

FIGS. 4 and 5 are views illustrating a seal according to some embodiments of the present disclosure.

FIG. 6 is a view illustrating a portion of a grease pocket of a dynamic seal according to an embodiment of the present disclosure.

FIG. 7 is a view illustrating a movement direction of a foreign substance entering the dynamic seal and a flow of grease in the grease pocket according to an embodiment of the present disclosure.

FIGS. 8 and 9 are views illustrating various embodiments of the dynamic seal of the present disclosure.

FIG. 10 is a side view illustrating the slinger of the in-wheel motor according to the present disclosure.

FIG. 11 is an enlarged view illustrating a portion indicated by a dashed-line in FIG. 10.

FIG. 12 is a side view illustrating a side of the slinger of the in-wheel motor according to the present disclosure.

FIGS. 13, 14, 15 and 16 are views illustrating various embodiments of the slinger of the in-wheel motor of the present disclosure.

The drawings described herein are for illustration purposes only and are not intended to limit the scope of the present disclosure in any way.

### DETAILED DESCRIPTION

Embodiments of the present disclosure are described below in detail with reference to the accompanying drawings. The following description is merely exemplary in nature and is not intended to limit the present disclosure, application, or uses. It should be understood that throughout the drawings, corresponding reference numerals indicate like or corresponding parts and features.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

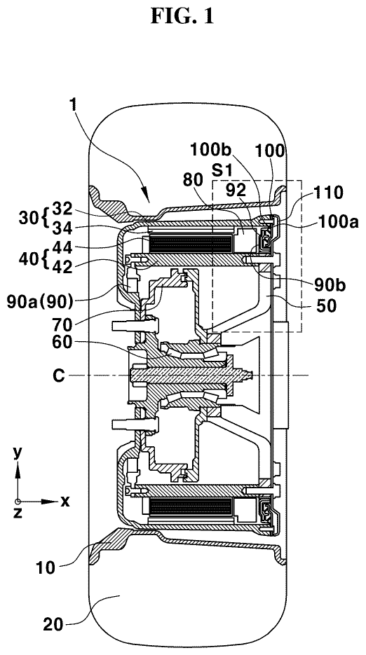

As illustrated in FIG. 1, an in-wheel motor 1 may be mounted within a wheel 10 of a vehicle. The x-axis direction corresponds to a lateral direction of the vehicle; the z-axis direction corresponds to a longitudinal direction of the vehicle; and the y-axis direction corresponds to a vertical direction. In addition, in the in-wheel motor 1 in FIG. 1, the left side is an outer side of the vehicle, and the right side is an inner side of the vehicle. Accordingly, the in-wheel motor 1 illustrated in FIG. 1 may be viewed as installed in a wheel on the driver's side of the vehicle. In addition, a tire 20 may be mounted on the wheel 10.

The in-wheel motor 1 may be configured to rotate and may directly rotate the wheel 10. The in-wheel motor 1 includes a rotor 30, which is a rotating part, and a stator 40, which is a stationary part.

In an embodiment, the in-wheel motor 1 may be an outer rotor-type motor in which the rotor 30 is disposed radially outward of the stator 40. The rotor 30 includes a rotor housing 32 and a first magnetic member 34 mounted on the rotor housing 32 to be rotatable with respect to the stator 40. The stator 4, which is a stationary part, is connected to the vehicle through a support bracket 50 and includes a stator housing 42 and a second magnetic member 44 coupled to the stator housing 42.

In some embodiments, both the first magnetic member 34 and the second magnetic member 44 may be electromagnets, wherein wires are wound in a coil shape around the rotor 30 and the stator 40, respectively. In some embodiments, one of the first magnetic member 34 and the second magnetic member 44 may be a permanent magnet, and the other may be an electromagnet. For example, the first magnetic member 34 may be a permanent magnet, and the second magnetic member 44 may be an electromagnet. For example, the first magnetic member 34 of the rotor 30 may be a permanent magnet, and the second magnetic member 44 may be an electromagnet.

The first magnetic member 34 and the second magnetic member 44 may electromagnetically interact with each other through magnetization of the second magnetic member 44 of the stator 40. The rotor 30 which includes the first magnetic member 34 is configured to be rotatable around an axis C of the wheel 10 with respect to the stator 40 which includes the second magnetic member 44. A wheel bearing 60 may couple the wheel 10, the rotor housing 32, and a brake 70 and be rotatable with respect to the stator 40. The brake 70 may be disposed radially outward of the wheel bearing 60 and be operably coupled to the in-wheel motor 1.

The in-wheel motor 1 further includes a high-temperature and high-voltage part 80. The high-temperature and high-voltage part 80 may be located at the stator 40. As a non-limiting example, the high-temperature and high-voltage part 80 may include a busbar configured to connect the second magnetic member 44, which is the coil of the stator 40, to a power source, an electrical component required to drive the in-wheel motor 1, or the like. Accordingly, the high-temperature and high-voltage part 80 is a high-voltage, high-temperature component in the in-wheel motor 1. For example, a temperature of the high-temperature and high-voltage part 80 may reach up to approximately 180 °C, and a voltage of the high-temperature and high-voltage part 80 may reach up to approximately 700 volts.

The first magnetic member 34 is disposed radially inward of the rotor housing 32. The stator housing 42 around which the second magnetic member 44 is wound is disposed radially inward of the first magnetic member 34. In this configuration, an air gap is present between the rotor 30 and the stator 40. The wheel bearing 60 and the brake 70 are disposed radially inward of the stator 40 and are coaxial with the stator 40. The wheel bearing 60 and the brake 70 are coupled to the rotor housing 32 to rotate together with the wheel 10. In an embodiment, one end of the rotor housing 32, except for its central portion, may be closed; and a support bracket 50 connected to the vehicle may be inserted into the stator 40 such that the other end of the rotor housing 32 may be coupled to the wheel bearing 60. After the rotor 30 and the stator 40 are coupled, a space between the rotor 30 and the stator 40 should be sealed.

The in-wheel motor 1 may be sealed by a dynamic seal or a seal 90 in an annular shape. The seal 90 may prevent intrusion of moisture, a foreign substance, or the like into the in-wheel motor 1. As a non-limiting example, the seal 90 may be made of a rubber material. The space between the rotor 30 and the stator 40 is sealed by the seal 90 at both sides in the x-axis direction, or an axial direction, of the rotor 30 and the stator 40. In an embodiment, the seal 90 includes an outer seal 90a disposed outward in a lateral direction (x-axis) of the vehicle and an inner seal 90b disposed closer to a central portion of the vehicle. In an embodiment, the outer seal 90a may have a larger diameter than the inner seal 90b. In an embodiment, the inner seal 90b may have a larger diameter than the outer seal 90a.

A large-diameter seal is required in the in-wheel motor 1 of the outer-rotor type. A large-diameter seal may refer to a seal applicable to the wheel 10 having a diameter of 16 inches or greater. For example, if the wheel 10 has a diameter of 16 inches or greater, the seal is required to have an outer diameter of approximately 350 millimeters (mm) or greater. A maximum linear velocity of the seal of this size may exceed 30 meters (m) per second. Such a high linear velocity may cause excessive friction on the seal, which may result in performance degradation of the in-wheel motor 1 and damage to the seal. Accordingly, due to its size, the large-diameter seal has greater difficulty satisfying the requirements compared to a small-diameter seal. In particular, the dynamic seal according to the present disclosure is designed to satisfy the requirements of such a large-diameter seal as well. The inner seal 90b is described below as an example of such a large-diameter seal. However, a structure of the inner seal 90b may also be applied to the outer seal 90a, and thus the inner seal 90b may also be referred to as a seal.

The seals may prevent leakage or contamination between relatively moving components. The inner seal 90b may be connected to the stator 40. In some embodiments, the inner seal 90b may be connected to the stator 40 through the support bracket 50. In some embodiments, the inner seal 90b and the support bracket 50 may be assembled or integrated into a single module, and the module may be assembled to the stator 40. For example, the inner seal 90b may be formed in an annular shape and secured to an outer peripheral portion of the support bracket 50. Specifically, by assembling an inner peripheral portion of the inner seal 90b to the outer peripheral portion of the support bracket 50, the inner seal 90b and the support bracket 50 may be integrated. In this configuration, a space occupied by the inner seal 90b and the support bracket 50 in the in-wheel motor 1 may be minimized such that a space inside the in-wheel motor 1 and a chassis connection space of the vehicle may be additionally ensured. For example, the connection of the busbar located inside the in-wheel motor 1 or the connection with a suspension located outside the in-wheel motor 1 may be made easier.

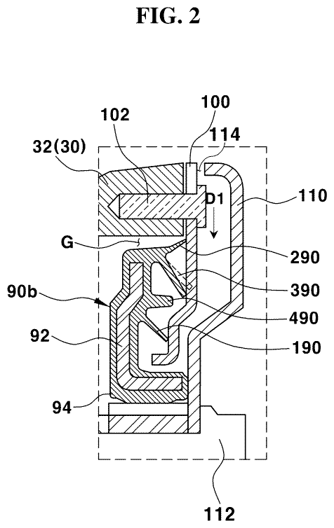

Referring to FIG. 2, the inner seal 90b may be mounted on the stator 40 to have a gap G of a predetermined distance from the rotor 30. The gap G allows the rotor 30 to rotate smoothly without interference. However, moisture, a foreign substance, etc., may enter into the in-wheel motor 1 through the gap G, and thus a slinger 100 in an annular shape may be mounted on the rotor 30. The slinger 100 may prevent moisture, a foreign substance, etc., from entering into the in-wheel motor 1 by directly blocking the gap G and by extending a pathway of moisture, a foreign substance, or the like that enters from the outside.

The slinger 100 is coupled to an end of the rotor 30. The slinger 100 extends along a circumferential direction of the rotor 30 and extends radially inward from the rotor 30 to a position between the rotor 30 and the stator 40. Accordingly, the slinger 100 is configured to at least partially overlap the inner seal 90b which is disposed between the rotor 30 and the stator 40.

The slinger 100 is coupled to the rotor housing 32 through a fastening member 102. As a non-limiting example, the fastening member 102 may be a bolt. The slinger 100 may be provided with a hole 108. The holes 108 may be provided along a periphery of the slinger 100, and the fastening member 102 may be inserted into the hole 108. The slinger 100 may be coupled to the rotor 30 through the fastening member 102 to reinforce the rigidity of the rotor 30 and facilitate disassembly, assembly, etc., of the slinger 100. Accordingly, the slinger 100 is recyclable, reduces associated costs, and is environmentally friendly.

Furthermore, the slinger 100 may be easily disassembled and assembled through the fastening member 102, which facilitates maintenance. In addition, the slinger 100 is made of a steel material having high thermal conductivity and is coupled to the end of the rotor 30 or outside the space between the rotor 30 and the stator 40, as described above. Accordingly, the slinger 100 is configured to easily dissipate heat generated by frictional contact with the inner seal 90b to the outside and suppresses a temperature rise in the inner seal 90b adjacent to the high-temperature and high-voltage part 80. As the cooling of the inner seal 90b becomes more efficient, seal deformation and degradation may be suppressed such that the durability of the inner seal 90b may also be enhanced. Additionally, the inner seal 90b made of rubber, resin, or the like is located between the high-temperature and high-voltage part 80 and the slinger 100 made of a steel material and serves as an insulator to prevent internal discharge.

A dust cover 110 may be disposed on the outside of the slinger 100. The dust cover 110 is coupled to the stator 40. Specifically, the dust cover 110 is fastened to the stator housing 42. The dust cover 110 may be coupled to the stator 40 via a fastening member, such as a bolt. The dust cover 110 may be detachably coupled to the stator 40 through a fastening member 112 to facilitate disassembly and assembly to facilitate maintenance. Also, the dust cover 110 becomes recyclable, which reduces costs and is environmentally friendly.

The dust cover 110 may be coupled to the in-wheel motor 1 from the outside of the inner seal 90b and the slinger 100 to keep the inner seal 90b and the slinger 100 from being dislodged. In other words, the dust cover 110 may serve as a stopper to prevent the inner seal 90b from being pushed out of the in-wheel motor 1 and may provide enhanced securing strength for the inner seal 90b, enhancing durability.

The dust cover 110 includes a passage 114. The passage 114 may refer to a small gap between a peripheral portion of the dust cover 110 and the slinger 100. The passage 114 may enable re-discharge of a foreign substance or the like that enters the dust cover 110 and may also provide a labyrinthine structure for the dynamic seal.

Specifically, the entry of a foreign substance, such as moisture, into the in-wheel motor 1 may be initially blocked by the dust cover 110. Even if a foreign substance enters the dust cover 110 through the passage 114 along an intrusion direction D1, the foreign substance may not move along an axial direction of the in-wheel motor 1 because the slinger 100 extends along a radial direction of the in-wheel motor 1. Even if a foreign substance that has entered moves along the slinger 100 and arrives at a space between the inner seal 90b and the slinger 100, further intrusion is hindered by the inner seal 90b.

The inner seal 90b may include a structure 92 and a main body 94. The structure 92 may be formed inside the main body 94 to retain a shape of the inner seal 90b. As a non-limiting example, the structure 92 may be made of steel. The structure 92 may be shaped similarly to the inner seal 90b and extend along the interior of the inner seal 90b. The main body 94 may include a plurality of lips configured to surround the structure 92 and extend from the main body 94.

According to an embodiment, the inner seal 90b includes a plurality of lips. The plurality of lips may block a foreign substance or the like from entering into the in-wheel motor 1. In an embodiment, the plurality of lips may be contact lips. In an embodiment, the amount of overlap of some of the plurality of contact lips may be differently set.

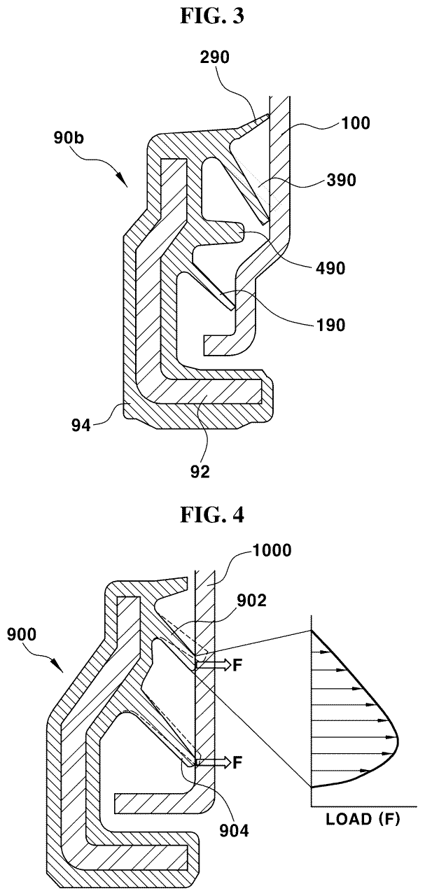

As illustrated in FIG. 3, the plurality of lips may include an upstream lip 190 and a downstream lip 290. The upstream lip 190 may be disposed upstream of the downstream lip 290 with respect to the intrusion direction D1 of a foreign substance. The downstream lip 290 may be disposed downstream of the upstream lip 190 with respect to the intrusion direction D1 of a foreign substance. In other words, the upstream lip 190 may be disposed radially inward of the in-wheel motor 1 relative to the downstream lip 290, and the downstream lip 290 may be disposed radially outward of the in-wheel motor 1 relative to the upstream lip 190.

The upstream lip 190 and the downstream lip 290 may be contact lips. Contact lips may refer to lips that contact the slinger 100. In an embodiment, the amount of overlap between the upstream and downstream lips 190 and 290 and the slinger 100 may be set to zero. Here, the overlap amount of zero may indicate a state where tips of the lips merely come into contact with the slinger 100 in a state where the in-wheel motor 1 is not rotating. Put differently, the overlap amount of zero may mean that a contact force between the lips and the slinger 100 is almost zero. The amount of overlap may refer to the amount of overlap between the lips and the slinger 100 in a state where the in-wheel motor 1 is not rotating.

In an embodiment, a length of the upstream lip 190 or the downstream lip 290 may be the same as a length from the body 94 of the inner seal 90b to the slinger 100 on a line drawn in the direction in which the upstream lip 190 or the downstream lip 290 extends. The amount of overlap being zero between the upstream lip 190 or the downstream lip 290 and the slinger 100 may refer to a state in which the upstream lip 190 or the downstream lip 290 contacts the slinger 100 in a non-rotating state of the in-wheel motor 1, without exerting a contact force between them.

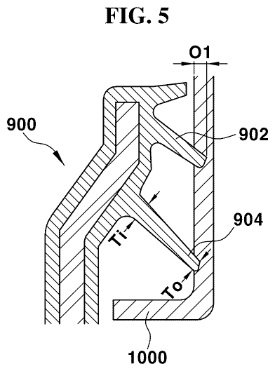

Referring to FIGS. 4 and 5, a seal 900 having a shape different from that of the inner seal 90b of the disclosed embodiments is used as an example to describe the thickness of a lip, an overlap amount O1 (or overlap) with a slinger 1000, and a contact force “F.” In general, the contact force (or reaction force) is generated in proportion to the overlap amount O1 (or overlap) set in the assembled state of a seal and a slinger. Contact force F increases in proportion to the overlap amount O1 as shown in FIG. 4, and, even with the same overlap amount O1, the contact force F varies depending on thicknesses Ti and To of lips 902 and 904. The contact force F (or reaction force) of the lip may be described by Equation 1.

F=kX [Equation 1]

Here, k is a constant proportional to the thickness of the lip, and X is proportional to the overlap amount.

The sealing performance and friction may be determined based on the magnitude and distribution of the contact force F.

In response to high-speed rotation of the in-wheel motor 1, a temperature of the lip and a sliding surface 100b of the slinger 100 rapidly rises due to friction. In addition, the high-speed rotation of the in-wheel motor 1 causes a strong centrifugal force to act on the slinger 100. The centrifugal force may scatter grease, which has increased in fluidity due to frictional heating, along a radial outer side of the slinger 100. Specifically, grease O is filled between the inner seal 90b and the slinger 100. During high-speed rotation of the rotor 30, heat is generated by the friction of the inner seal 90b. This causes the temperature of the inner seal 90b and the grease O to rise, resulting in flow of the grease O. The flowing grease O may escape from a space (or a grease pocket) between the inner seal 90b and the slinger 100, and may leak toward the gap G or toward the dust cover 110. Decrease in the amount of grease O in the space between the inner seal 90b and the slinger 100 increases the friction of the inner seal 90b and accelerates wear of the inner seal 90b, resulting in overheating due to insufficient lubrication. As a result, white smoke and damage to the inner seal 90b may occur. Although grease generally has low fluidity, in a large-diameter dynamic seal, such as the inner seal 90b, fluidity may increase due to heat generation caused by a high linear velocity during high-speed rotation of the in-wheel motor 1. As the large diameter of the inner seal 90b increases the amount of grease filled, scattering of the grease may easily occur.

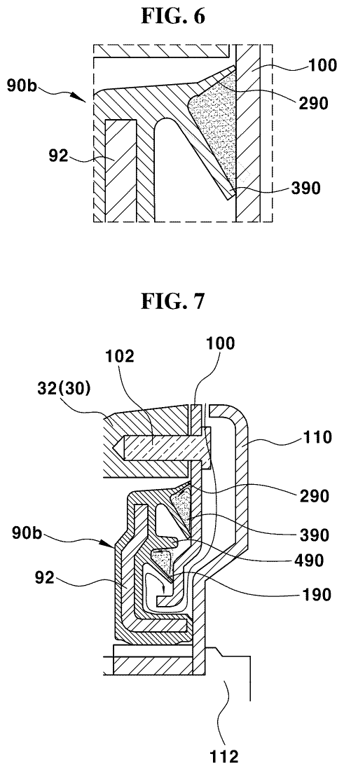

For example, at 1,800 revolutions per minute, the temperature may exceed 260 °C According to the present disclosure, as illustrated in FIG. 6, the downstream lip 290 may serve as a contact lip to prevent the grease from leaking out of the space between the seal and the slinger 100 to physically block the grease from moving into the in-wheel motor 1 due to centrifugal force. Also, the amount of overlap between the upstream lip 190 or the downstream lip 290 and the slinger 100 may be set to zero to minimize friction generated by the upstream lip 190 and the downstream lip 290, which are contact lips.

In an embodiment, the plurality of lips may include an intermediate lip 390. The intermediate lip 390 may be disposed between the upstream lip 190 and the downstream lip 290. The intermediate lip 390 may be a contact lip. In an embodiment, the intermediate lip 390 may be a contact lip having an amount of overlap with the slinger 100 greater than zero. In an example, the amount of overlap between the intermediate lip 390 and the slinger 100 may be 1.0 millimeter (mm) or more. The intermediate lip 390 indicated by hatching in the drawings shows a post-assembly state, and the intermediate lip 390 indicated by the dotted line shows a pre-assembly state.

The intermediate lip 390 may have a greater amount of overlap than the upstream lip 190 or the downstream lip 290 to prevent grease from scattering toward the radial outer side of the slinger 100. In general, the frictional force of a seal increases in proportion to the number of contact lips. In the dynamic seal of the present disclosure, friction of the seal may be reduced by setting the intermediate lip 390 alone to have an overlap amount greater than zero; and the sealing performance of the dynamic seal may be enhanced through the arrangement of the upstream lip 190 and the downstream lip 290 and a dam 490 and the shape of the slinger 100, which is described below.

According to an embodiment, each of the lips 190, 290, and 390 may be thinned. Each of the lips 190, 290, and 390 extends from the body 94 of the inner seal 90b. The thickness of each of the lips 190, 290, and 390 may decrease along a direction of the extension. The thickness on the body side of each of the lips 190, 290, and 390, or the thickness Ti of the thickest portion of each of the lips 190, 290, and 390 may be in a range of approximately 1.0 mm to 1.5 mm, and may be 1.1 mm. The thickness To at tips of each of the lips 190, 290, and 390 may be smaller than the thickness Ti. According to the present disclosure, the inner seal 90b having a lip of a smaller thickness may reduce frictional loss by decreasing the reaction force of the lip made of rubber. Additionally, according to the present disclosure, contact force generation caused by assembly deviations or variations in the amount of overlap, which may occur during rotation of the in-wheel motor 1, may be minimized.

As illustrated in FIG. 7, in an embodiment, the inner seal 90b may include the dam 490. The dam 490 may extend from the body 94 of the inner seal 90b toward the slinger 100. The dam 490 may extend toward the slinger 100 without coming into contact with the slinger 100.

In a large-diameter dynamic seal, the length of the lip and the grease pocket between the lips also increase in proportion to the size of the large-diameter dynamic seal. Accordingly, the large-diameter dynamic seal should be filled with a large amount of grease. The large amount of grease may generate flow resistance against the slinger 100 during rotation of the in-wheel motor 1 and consequently increase rotational loss of the in-wheel motor 1. By reducing the volume of the grease pocket, the dam 490 disposed in the grease pocket may reduce the amount of grease filled. Furthermore, as indicated by the arrow, the dam 490 may prevent the grease from leaking out of the grease pocket by obstructing the movement of the grease. In addition, the dam 490 may form a labyrinthine structure and enhance the sealing performance of the inner seal 90b.

In some embodiments, the dam 490 may be disposed between some lips of the plurality of lips. As in the embodiments illustrated, the dam 490 may be disposed between the intermediate lip 390 and the upstream lip 190. The dam 490 disposed between the lips may reinforce the labyrinth structure, which makes entry of a foreign substance difficult, and may reduce the amount of grease filled.

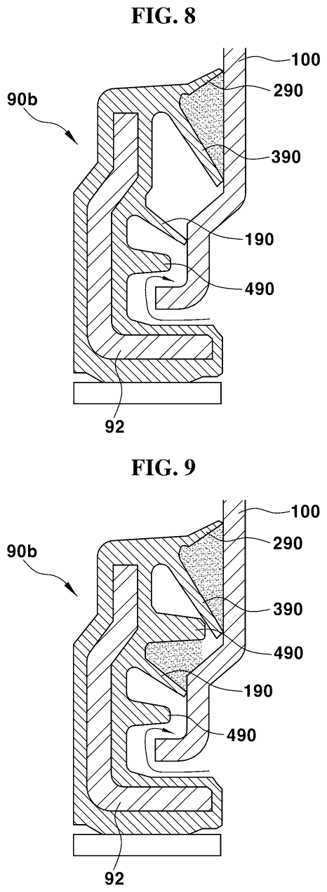

Referring to FIG. 8, in some embodiments, the dam 490 may be disposed adjacent to some lips of the plurality of lips. For example, the dam 490 may be disposed upstream of the upstream lip 190. The dam 490 disposed upstream of the upstream lip 190 may reinforce the labyrinthine structure.

As illustrated in FIG. 9, in some embodiments, the inner seal 90b may include one or more dams 490. For example, a single dam 490 may be disposed upstream of the upstream lip 190. An additional dam 490 may be disposed between the upstream lip 190 and the intermediate lip 390. The one or more dams 490 may reduce the amount of grease filled and reinforce the labyrinth structure.

According to the present disclosure, the dynamic seal may include a structure capable of reducing friction between the slinger 100 which is a rotating part of the in-wheel motor 1 and the inner seal 90b which is a stationary part of the in-wheel motor 1. With such a structure, the dynamic seal of the present disclosure may provide a large-diameter seal, which may be used reliably in an in-wheel motor of the outer-rotor type for driving an electric vehicle and respond to a high linear velocity.

During high-speed rotation of the rotor 30, a large-diameter seal experiences increased friction with the slinger 100 due to a high linear velocity, resulting in heat generation and wear. For example, as an outer diameter of the inner seal 90b increases, a circumferential velocity of the inner seal 90b increases, and the friction increases. The increased friction may deteriorate the energy efficiency of the electric vehicle. Moreover, the increased friction generates heat and increases the wear of the inner seal 90b. This shortens a replacement cycle of the inner seal 90b and deteriorates the durability of the inner seal 90b.

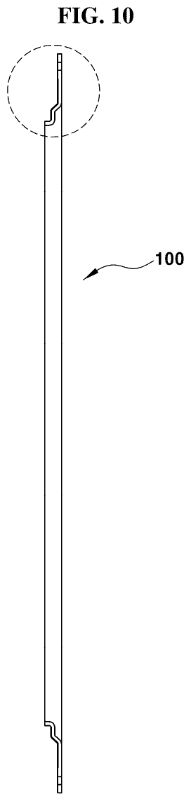

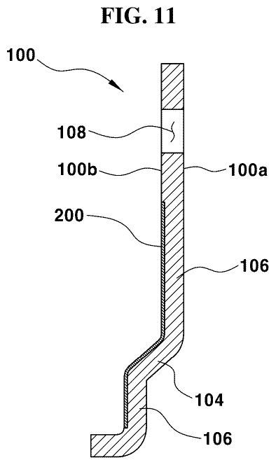

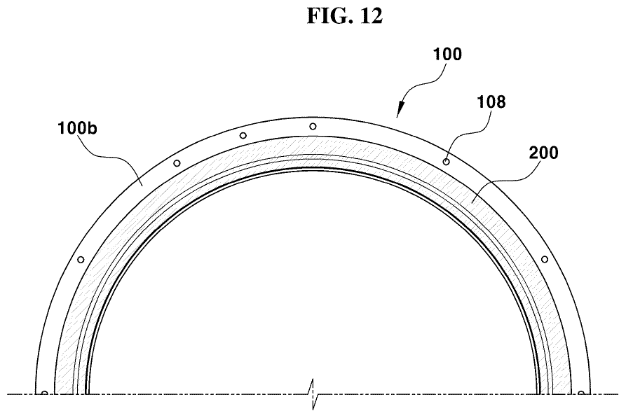

As illustrated in FIGS. 10 and 11, the slinger 100 includes an opposing side surface 100a and the sliding surface 100b. The sliding surface 100b is disposed to face the inner seal 90b and is configured to come into contact with the lips 190, 290, and 390. The opposing side surface 100a, which is a surface opposite to the sliding surface 100b, may face the dust cover 110.

Referring to FIG. 12, according to an embodiment, the sliding surface 100b of the slinger 100 may undergo surface treatment. The sliding surface 100b is a surface with which the lip of the inner seal 90b comes into contact, and a low-friction, low-wear coated surface 200 may be applied to the sliding surface 100b. As a non-limiting example, the material of the low-friction, low-wear coated surface 200 may include a polymer or diamond-like carbon (DLC). In an example, the polymer may include a fluoropolymer, and the polymer may include polytetrafluoroethylene (PTFE). The coated surface 200 may greatly reduce rotational friction and may also greatly reduce heat generation under the highest speed condition of the in-wheel motor 1. Experimental results show that rotational friction of the slinger 100 is reduced by 50% or more compared to the slinger 100 without coating, and heat generation is reduced by 50 °C or more under the highest speed condition.

According to an embodiment, the slinger 100 may include a bending portion 104. In an embodiment, the bending portion 104 may have a stair-step shape. During operation of the in-wheel motor 1, various loads may act on the in-wheel motor 1. Here, the loads may include: internal loads, such as a thermodynamic load and an electromagnetic force; and external loads, such as a combined longitudinal and lateral load generated during vehicle driving. The load acting on the in-wheel motor 1 as described above may cause deformation of the rotor 30 and may lead to behavior and deformation of the slinger 100 fastened to the rotor 30. According to the present disclosure, the slinger 100 may include the bending portion 104 in a stair-step shape to suppress physical deformation in response to an external load that is difficult to control. In addition, according to the present disclosure, through the low-friction structure of the lip and the low-friction surface treatment of the slinger 100 as described above, frictional heat generation may be reduced to suppress thermal deformation. Additionally, rigidity of the slinger 100 including the bending portion 104 is reinforced, which may also suppress the deformation of the rotor 30 to which the slinger 100 is fastened to enhance the robustness to retain the air gap of the in-wheel motor 1.

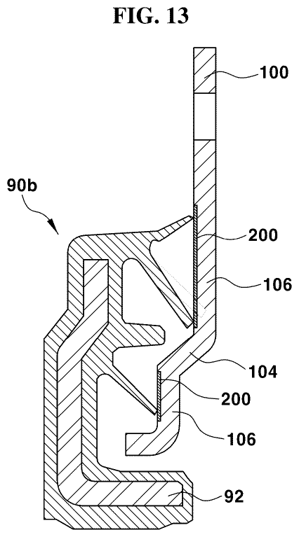

As illustrated in FIG. 13, in some embodiments, the slinger 100 may include a single bending portion 104. The single bending portion 104 may form two linear sections 106 in the slinger 100. The coated surface 200 may be formed on the linear sections 106. The downstream lip 290 and the intermediate lip 390 may be disposed to come into contact with the coated surface 200 formed on one of the two linear sections 106.

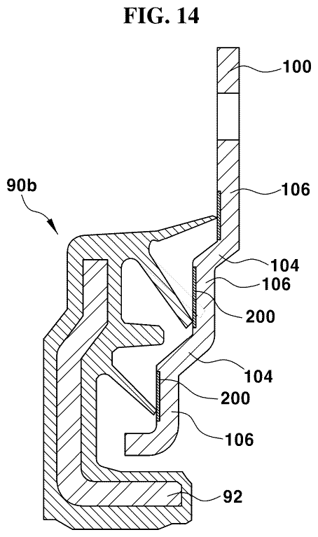

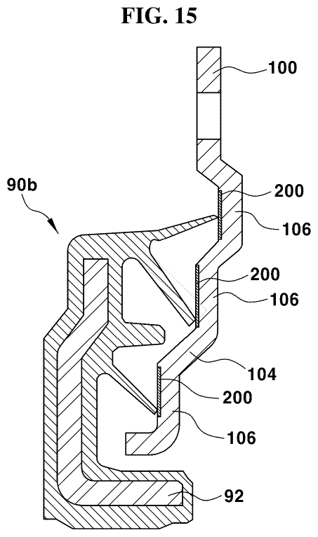

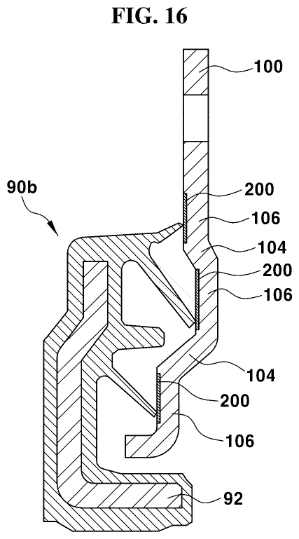

Referring to FIGS. 14, 15, and 16, in some embodiments, the slinger 100 may include at least two bending portions 104. The at least two bending portions 104 may form three linear sections 106 in the slinger 100. The coated surface 200 may be formed on each of the linear sections 106, and the linear sections 106 may be disposed to come into contact with the upstream lip 190, the intermediate lip 390, and the downstream lip 290, respectively. In some embodiments, the directions of each of the bending portions 104, among the at least two bending portions 104, may be differently formed from one another.

The dynamic seal and the in-wheel motor including the same according to the present disclosure may include a contact lip to prevent grease from scattering under an ultra-high speed condition of the in-wheel motor. Also, the amount of overlap between the upstream lip 190 and the downstream lip 290 of the dynamic seal may be set to zero to minimize reaction force and reduce friction caused by assembly deviations or variations in the amount of overlap under an actual driving condition. The dynamic seal and the in-wheel motor including the same according to the present disclosure may also reduce the thickness of the upstream lip 190, the downstream lip 290, and the intermediate lip 390 to minimize grease leakage and heat generation.

The dynamic seal and the in-wheel motor including the same according to the present disclosure may include a single intermediate lip 390 having an overlap amount greater than zero and enable reduction in reaction force by thinning to secure sealing performance and reduce frictional loss.

The dynamic seal and the in-wheel motor including the same according to the present disclosure may include the low-friction coated surface 200 on the sliding surface 100b of the slinger 100 to reduce rotational friction and heat generation of the seal.

The dynamic seal and the in-wheel motor including the same according to the present disclosure may include the slinger 100 including step bending to suppress the deformation of the slinger 100 itself and the deformation of the rotor 30 fastened to the slinger 100 under a severe combined load condition on an actual driving road to reduce noise, vibration, and harshness (NVH) and enhance durability.

The dynamic seal and the in-wheel motor including the same according to the present disclosure may include the dam 490 to reduce the amount of grease filled by reducing the volume of the grease pocket, prevent leakage of grease from the grease pocket by obstructing the movement of grease, and enhance the sealing performance by forming a labyrinthine structure.

What is claimed is:

1. An in-wheel motor comprising:
a stator;
a rotor rotatable with respect to the stator; and
a seal disposed on the stator and configured to contact the rotor,
wherein the seal comprises:
a first lip, and
a second lip spaced apart from the first lip, and
wherein the first lip and the second lip contact the rotor and have an overlap amount of zero with the rotor.

2. The in-wheel motor of claim 1, wherein the rotor comprises a slinger coupled to the rotor, and the seal is disposed to contact the slinger.

3. The in-wheel motor of claim 2, wherein the slinger comprises a coated surface, and the first lip and the second lip come into contact with the coated surface.

4. The in-wheel motor of claim 2, wherein the slinger comprises at least one bending portion.

5. The in-wheel motor of claim 2, wherein the slinger comprises:
a first linear portion;
a bending portion bent from the first linear portion; and
a second linear portion configured to extend from the bending portion.

6. The in-wheel motor of claim 5, wherein each of the first linear portion and the second linear portion comprises a coated surface, and the first lip and the second lip are configured to respectively contact the coated surfaces of the first linear portion and the second linear portion.

7. The in-wheel motor of claim 2, wherein the seal further comprises a first dam configured to extend from a body of the seal toward the slinger without contacting the slinger.

8. The in-wheel motor of claim 7, wherein the first dam is disposed between the first lip and the second lip.

9. The in-wheel motor of claim 7, wherein the first dam is disposed between the first lip and the second lip, and
wherein the seal further comprises a second dam extending from the body of the seal toward the slinger, and the second dam is disposed outside a region between the first lip and the second lip.

10. The in-wheel motor of claim 1, wherein:
the seal further comprises a third lip disposed between the first lip and the second lip, and
the third lip contacts the rotor, and an amount of overlap between the third lip and the rotor is greater than zero.

11. The in-wheel motor of claim 1, wherein the stator is disposed radially inward of the rotor.

12. An in-wheel motor comprising:
a stator;
a rotor disposed on an outer side of the stator and configured to rotate relative to the stator;
a seal disposed on the stator; and
a slinger disposed on the rotor and configured to contact the seal,
wherein the seal comprises:
a first lip;
a second lip spaced apart from the first lip; and
a third lip disposed between the first lip and the second lip, and
wherein the first lip, the second lip, and the third lip contact the slinger, wherein an overlap amount between the first and second lips and the slinger is zero, and an overlap amount between the third lip and the slinger is greater than zero.

13. The in-wheel motor of claim 12, wherein the slinger comprises a coated surface, and the coated surface is coated with polytetrafluoroethylene (PTFE).

14. The in-wheel motor of claim 13, wherein the first lip, the second lip, and the third lip contact the coated surface.

15. The in-wheel motor of claim 12, wherein the slinger comprises a linear portion and a bending portion having an angle with respect to the linear portion.

16. The in-wheel motor of claim 15, wherein the linear portion comprises a coated surface, and the first lip, the second lip, and the third lip come into contact with the coated surface.

17. The in-wheel motor of claim 12, wherein a thickness of the first lip, the second lip, and the third lip is within a range of 1.0 millimeter to 1.5 millimeters.

18. The in-wheel motor of claim 12, wherein the seal further comprises a first dam disposed between the first lip and the second lip, the first dam extending toward the slinger.

19. The in-wheel motor of claim 18, wherein the seal further comprises a second dam extending toward the slinger and disposed outside a region between the first lip and the second lip.

20. A dynamic seal comprising:
a first lip;
a second lip spaced apart from the first lip; and
a third lip disposed between the first lip and the second lip,
wherein the first lip, the second lip, and the third lip contact a rotor,
wherein the rotor is configured to rotate relative to a stator and includes a slinger, and
wherein an overlap amount between the first and second lips and the slinger is zero, and an overlap amount between the third lip and the slinger is greater than zero.
